(19) United States
(12) Patent Application Publication
(10) Pub. No.: US 2018/0307900 A1
(43) Pub. Date: Oct. 25, 2018

(54) Display Systems Using Facial Recognition for Viewership Monitoring Purposes

(71) Applicant: IDK Interactive Inc., Winnipeg (CA)

(72) Inventors: Charlie Tago, Winnipeg (CA); David Wang, Shenzhen (CN); Tago Ranginya, Abu Dhabi (AE); Jeffrey Hiebert, Winnipeg (CA)

(21) Appl. No.: 15/576,779

(22) PCT Filed: Aug. 27, 2015
(86) PCT No.: PCT/CA2015/050823

§ 371 Date: Nov. 24, 2017

Related U.S. Application Data
(60) Provisional application No. 62/166,804, filed on May 27, 2015.

(51) Int. Cl. G06K 9/00; G06Q 30/02

(52) U.S. Cl. CPC G06K 9/00288; G06Q 30/0242

(57) ABSTRACT

A computerized system for displaying advertising or other informational content and monitoring viewership of same features a plurality of display devices connected to a facial recognition server and a backend server via a communications network. Each display device includes a visual display for displaying the content, and a camera for capturing digital images of a surrounding environment. Captured images are forwarded to a facial recognition server, which performs detection and analysis of facial characteristics of viewers' faces captured within the digital images. For each image, results of the analysis are received by the backend server, and stored in association with a timestamp of the image and identification of the particular display device that captured the image. Reports on the viewership of a particular display device and/or specific content are generated, for example for use by an advertiser associated with that specific content.

### FIELD OF THE INVENTION

The present invention relates to computerized solutions for tracking viewership of displayed content on electronic devices, for example for statistical purposes.

### BACKGROUND

In the field of advertising, it is useful for advertisers to be able to track viewership of advertising content, for example for the purpose of monitoring demographics to whom the content is being conveyed, which allows advertisers to assess whether target demographics are being successfully targeted, or to identify demographics to whom the advertised product appeals so that future ads or marketing campaigns can be targeted accordingly.

Applicants of the present application have been in development of informational kiosks and associated software for presenting interactive content in public spaces, and in doing so, a solution to track both user viewership and interaction of content on such kiosks was conceptualized, which would offer improvement over an earlier kiosk trial model that lacked the ability to provide the early adopter clients with data on user demographics.

From the initial concept, a working process was derived and tested, details of which are disclosed herein below, thereby accomplishing a novel and inventive solution for tracking viewership of advertising or content on informational kiosks or other electronic devices.

### SUMMARY OF THE INVENTION

According to a first aspect of the invention, there is provided a display device with viewer data collection capabilities, the device comprising:

a processor;

at least one computer readable memory medium coupled to the processor and comprising computer readable memory having stored thereon statements and instructions for execution by the processor;

a display connected to the processor and operable to display visual content thereon; and

a camera connected to the processor and operable to capture digital images of a surrounding environment in which the device resides;

wherein the statements and instructions are configured to:
trigger capture of a digital image by the camera and store said digital image on the computer readable memory medium; and
initiate a facial recognition process for performing detection and analysis of facial characteristics of a viewer whose face was recorded within the digital image.

Preferably there is provided a network connection interface coupled to the processor and operable to connect to a communications network and communicate with a remote facial recognition server via said communications network, wherein the statements and instructions are configured to forward the digital image data through the communications network to the remote facial recognition server for detection and analysis of facial characteristics of a viewer whose face was captured within the digital image.

Preferably the statements and instructions are configured to perform a modification of the digital image and generate the digital image data from said modification.

Preferably the statements and instructions are configured to adjust a brightness of the digital image during said modification.

Preferably the statements and instructions are configured to reduce a size of the digital image during said modification.

Preferably the statements and instructions are configured to reduce a size of the digital image during said modification.

Preferably the statements and instructions are configured to convert a file format of the digital image from one format to another.

Preferably the statement and instructions are configured to retrieve or accept results of the analysis from the facial recognition server, and store said results of the analysis in association with local data from the display device.

Preferably the local data comprises a timestamp associated with the capture of the digital image.

Preferably the local data comprises a device ID of the display device.

Preferably the local data comprises a content ID associated with a visual content item shown on the display when the digital image was captured.

Preferably the statements and instructions are configured to store said results of the analysis, and said local data from the display device, at a remote server accessed through the communications network.

According to a second aspect of the invention, there is provided a server for use with a remotely located display device that is configured to capture a digital image of one or more viewers of said display device, the server comprising:

a processor; and

at least one computer readable memory medium coupled to the processor and comprising computer readable memory having stored thereon statements and instructions for execution by the processor;

wherein the statements and instructions are configured to:
receive results from a facial recognition process performed on the digital image; and
store said results in association with data concerning the display device at which the digital image was captured.

Preferably said data comprises a device ID of the device.

Preferably said data comprises a content ID associated with a visual content item shown on a display of the display device when the digital image was captured.

Preferably said data comprises a timestamp indicative of a time at which the digital image was captured by the display device.

Preferably the statements and instructions are configured to generate a report concerning viewership of visual content displayed on the display device based on the results from the facial recognition process and associated data concerning the digital image.

Preferably the statements and instructions are configured to cause display of said report.

According to a third aspect of the invention, there is provided a method of monitoring viewership of content displayed on a plurality of display devices, the method comprising:

electronically storing results from a facial recognition process performed on digital images captured by cameras of the display devices, including storing the result from each facial recognition process in association with data concerning the display device at which the respective digital image was captured;

generating a report concerning viewership of visual content displayed on the display devices based on the results from the facial recognition process and associated data concerning the digital images.

The method may comprise generating a device-specific report using only the results for which the data concerning the display device comprises a specific device ID assigned to a particular one of the display devices.

The method may comprise generating the report comprises generating a content-specific report using only the results for which the data concerning the display devices comprises a specific content ID for a particular piece of visual content shown on the display devices.

According to a fourth aspect of the invention, there is provided a computerized system for displaying advertising or other informational content and monitoring viewership of same, the system comprising:

a plurality of display devices each comprising a display operable to display visual content thereon, and a camera connected to the processor and operable to capture digital images of a surrounding environment in which the display device resides, each display device being configured to trigger capture of a digital image by the camera and store said digital image on the computer readable memory medium, and initiate a facial recognition process for performing detection and analysis of facial characteristics of a viewer whose face was recorded within the digital image; and

a server connected to a communication network and configured to receive results from the facial recognition process via said communication network, and store said results in association with data concerning which one of said display devices captured the digital image.

Preferably said data comprises a device ID of a specific one of said display devices that captured the digital image.

Preferably said data comprises a content ID associated with a visual content item shown on a display of the specific one of said display devices when the digital image was captured.

Preferably said data comprises a timestamp indicative of a time at which the digital image was captured by the display device.

Preferably the server is configured to generate at least one report concerning viewership of visual content displayed on the display devices based on the results from the facial recognition process.

Preferably the at least one report includes a device-specific report using only the results for which the device ID is the same.

Preferably the at least one report includes a content-specific report using only the results from the facial recognition process for which the content ID is the same.

Preferably the server is configured to cause display of said at least one report.

Preferably each display device is configured to forward the captured digital image to a remote facial recognition server to initiate the facial recognition process, which is performed by said facial recognition server, which forwards the results to the backend server via the communications network.

### BRIEF DESCRIPTION OF THE DRAWINGS

One embodiment of the invention will now be described in conjunction with the accompanying drawings in which:

FIG. 1 is a schematic illustration of a system using facial recognition to gather viewership data on viewers of informational terminals used to display advertising, media or other informational content in public settings.

FIG. 2 is a schematic block diagram of one of the informational terminals.

FIG. 3 is a flow chart illustrating an image capture and processing sequence in which the informational terminal captures a digital image, which may contain a facial image of one or more viewers of the terminal, processes the image, and transfers the processed image data to an external facial recognition server.

FIG. 4 is a flow chart illustrating a subsequent result retrieval sequence in which output from the facial recognition process is obtained by the informational terminal, and forwarded to a separate database server.

In the drawings like characters of reference indicate corresponding parts in the different figures.

### DETAILED DESCRIPTION

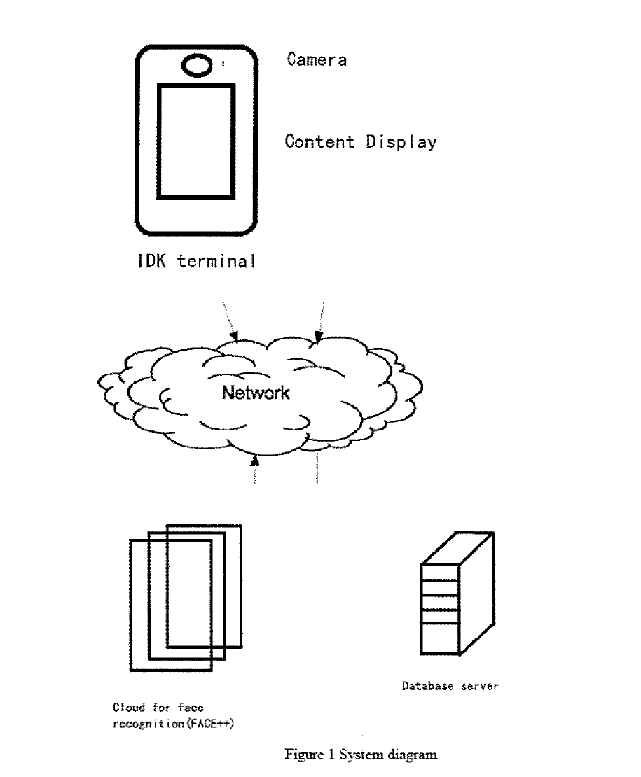

FIG. 1 schematically illustrates a viewership monitoring system incorporating a unique display terminal, and using an external, e.g. cloud-based, face-recognition system, and a backend database server for report generation for viewership measurement of an advertisement or media broadcast. The display terminals take digital photos of the viewers, and the facial recognition results are stored in the backend database for statistical analysis and report generation. By assigning different roles of each device, the whole process can be done in a flawless and cost-effective way. The final data collected may also be used for further data mining purposes.

With reference to FIG. 1, the system employs a plurality of display terminals (only one of which is shown for illustrative simplicity) with uniquely different hardware IDs, and which are connected to a communications network, for example the Internet, by which each such terminal can communicate with the external facial recognition server and the system's backend database server.

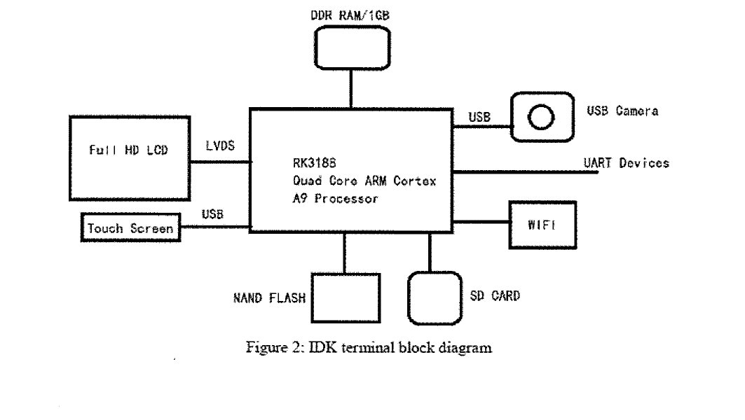

With reference to FIG. 2, each display terminal of the illustrated embodiment is a computer terminal having a processor, e.g. a quad-core processor (RK3188 from Rockchip inc, Quad ARM cortex A9) running at 1.6 Ghz core frequency; an operating system, e.g. Android, run by the processor; one or more computer readable memory mediums, which may be built into the system board, e.g. 1 GB DDR2 memory and 8 GB NAND non-volatile flash memory for the operating system; a display screen, e.g. a full HD (1920×1080 resolution) LCD display screen connected to the processor by LVDS link; a touch screen apparatus operably associated with the display, e.g. an IR touch screen apparatus connected to a USB port of the device with an internal driver that supports multi-touch functionality; a camera, e.g. a Logitech USB web camera, for acquiring the digital images of viewers in the front of the display screen; and a network connection interface, e.g. integrated WIFI (802.11g/n) on the main board, which provides the network connection for interaction with the two servers. Other devices or equipment may optionally be connected to the terminal, e.g. NFC readers, etc., for example via a UART port.

Anonymous Video Intelligence (AVIA) software is integrated into the terminal, being stored on the computer readable memory medium for execution by the processor. The AVIA software is run as a background service in the Android operating system. Unlike a normal application, the background service normally has no visible user interface shown onscreen while running in the background. The AVIA software may be configured to automatically start together with the android system once it is installed. When the software is running, it takes digital photos from the camera on a regular periodic basis, for example once every second, and stores the same on the computer readable memory medium. The periodic intervals at which the terminal captures images may be pre-defined, or be user-variable to allow customization or performance-adjustment of the system. There is a time stamp for each sent and returned message.

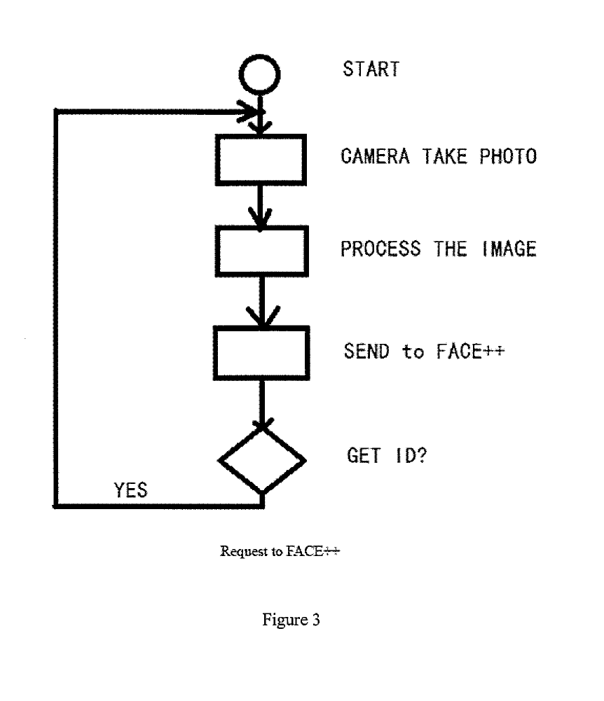

The captured digital images incorporate a timestamp in the saved image data. Timestamp here means the time when the photo was taken; and may be in the format YYYYMMDDHHMMSS. For example, a timestamp of 20150101120110 means the photo was taken on Jan. 1, 2015, at 12:01:10. The software processes the photo to have suitable size and correct format which is required by the external facial recognition server, which may be a cloud-based facial recognition server, such as that currently operated under the name FACE++. Once the image file has been processed locally at the terminal, the modified image data is then transmitted to the FACE++ server. The server sends back an acknowledgement with the ID of the image file. This process, shown schematically in FIG. 3, is then repeated at the prescribed periodic interval, e.g. once a second, on an ongoing basis.

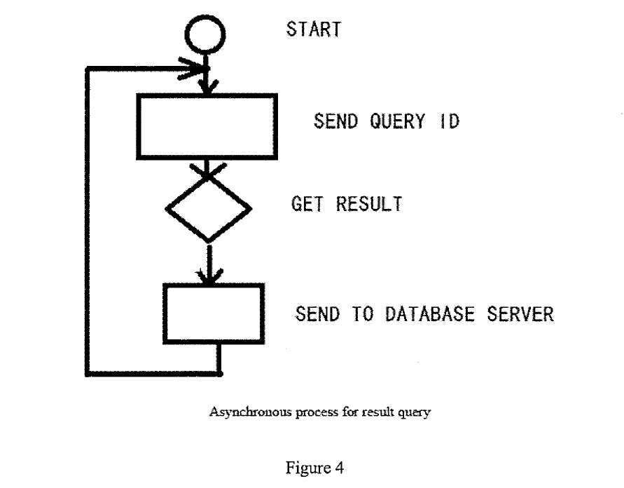

Due to the load of the server and network traffic status, an asynchronous method may be used to acquire the results from the FACE++ server. As shown in FIG. 4, at the instruction of the AVIA software, the terminal sends a query to the FACE++ server with the previously provided image ID, to which the FACE++ server replies with the results of the facial-detection analysis for that image. Normally, the final analysis results are received in a few seconds. The AVIA software selects the necessary information from the results, and posts the same to the back end database server for recording. The database server features a processor, at least one computer readable memory medium, including non-volatile computer readable memory storing software thereon with statements and instructions for execution by the processor, and additional non-volatile computer readable memory in which the database is stored maintained.

The FACE++ server runs the face recognition process. In one embodiment, the server performs image processing to find 83 points of one face and get the relative position of each point. This is the basis for the server software to identity the faces. The following list outlines required and optional input parameters that the FACE++ server receives from the display terminal.

| Name | | Description |
|---|---|---|
| Required | api_key | Registered API Key |
| | api_secret | Registered API Secret |
| | url or | url of the image to be detected, or the binary |
| | img[POST] | data of the image uploaded via POST. |
| Optional | mode | The detector mode, one of normal(default) or |
| | | oneface. In oneface mode, only the largest face |
| | | in the image would be found. |
| | attribute | Can be none or a comma-separated list of |
| | | desired attributes. Gender, age, race, smiling |
| | | are default. Currently supported attributes are: |
| | | gender, age, race, smiling, glass and pose. |
| | tag | A string to be associated with the faces, which |
| | | could be later retrieved via/info/get_face. |
| | | Should not exceed 255 characters. |
| | async | If set to true, the API would be invoked |
| | | asynchronously (i.e. a session id would be |
| | | returned immediately, which could be later |
| | | used to retrieve the result via/info/get_session). |
| | | Defaults to false. |

In the present embodiment, the async value is set to true, and binary image data stored locally on the display terminal is uploaded to the FACE++ server, but other embodiments may vary.

The following list outlines return values received from the FACE++ server in the result set of each facial recognition analysis.

| Field | Type | Description |
|---|---|---|
| session_id | string | Unique id of a session |
| url | string | Image url as specified in the request |
| img_id | string | Unique id of an image on Face++ platform |
| face_id | string | Unique id of a detected Face on Face++ platform |
| img_width | integer | Image width in pixels |
| img_height | integer | Image height in pixels |
| faces | array | A list of detected faces, each element is a |
| | | description of Face |
| width | float | The width of detected face (as 0-100% of image |
| | | width) |
| height | float | The height of detected face (as 0-100% of image |
| | | width) |
| center | object | x & y coordinates of the center point of the |
| | | detected face rectangle, as 0-100% of photo width |
| | | and height |
| nose | object | x & y coordinates of nose, as 0-100% of photo |
| | | width and height |
| eye_left | object | x & y coordinates of left eye, as 0-100% of photo |
| | | width and height |
| eye_right | object | x & y coordinates of right eye, as 0-100% of |
| | | photo width and height |
| mouth_left | object | x & y coordinates of left edge of mouth, as |
| | | 0-100% of photo width and height |
| mouth_right | object | x & y coordinates of right edge of mouth, as |
| | | 0-100% of photo width and height |
| attribute | object | List of detected facial attributes (currently |
| | | gender and age) |
| gender | object | Male/Female value and confidence |
| age | object | Estimated age value and range |
| race | object | Asian/Black/White value and confidence |
| smiling | object | Estimated smiling degree |
| glass | object | None/Dark/Normal value and confidence |
| pose | object | Including pitch_angle, roll_angle, yaw_angle, |
| | | in degree. |

The AVIA software may be configured to forward the full return data set received from the facial recognition server to the database server, or only forward the values of a particular subset of the return data fields. The data transmitted to the database server at this stage additionally includes the timestamp value of the particular image, and a terminal ID of the terminal in question.

All the forwarded face recognition results are stored in the database server of IDK. For each photo, this data includes the terminal ID, timestamp, faceID, and the results of recognition (gender, age, wearing glass, race etc). The most important process is to link the terminal ID and timestamp to the facial recognition results of each image, whereby for each photo, the system tracks which terminal the photo was taken at, and at what time. By checking the timestamp, the system can calculate viewer statistics for one terminal within a certain time period.

Storing the received data from a plurality of terminals that are each capturing images on an ongoing periodic bases, the database server will have a lot of data on faces (views) with terminal IDs and timestamps, which is used generate any of a number of different possible reports from which useful information can be found. For example, the system can calculate statistics for a given terminal ID during a given period, from which values can be calculated for flow of people and viewing time of the display terminal.

Turning back to the start of the process, as mentioned above, first the AVIA software causes the process to trigger the camera module to capture a digital image of the environment in which the terminal is located, which at that given point in time, may have the face of one or persons in the sightline of the camera, which is aimed in a manner such the face of a person currently viewing the display screen of the terminal would be expected to be contained within the image. The image file is then processed by the AVIA software to make it suitable for sending to the remote server. This process may include cutting and/or resizing, e.g. adjusting the size of the image file to the be smaller, which will reduce the transmission time over the Internet and also meet the requirement of Face++ server; and converting the image file to a format compatible with the Face++ requirements, e.g. converting the image to JPEG format for a good balance between file size and image quality. In the present embodiment, the image processing also adjusts the brightness of the photo to avoid the interference from changes in ambient/environmental lighting.

The second step is to send the processed image file to the remote server. The remote server provided by FACE++ has a set of API, which has some requirements on the input images. The face recognition software running on the FACE++1 server is like an infrastructure for all the incoming requests. The image sent by AVIA will be in a queue in the processing server network. Once the server finishes the recognition, it will return a message to the sender program, which in this case is the AVIA software within the display terminal. Depending on the network status, the returned message may have a delay up to 30 seconds or longer. While other embodiments could employ locally executed facial recognition algorithms as part of the AVIA software, the facial recognition process is not a simple image processing technique; it involves a tremendous amount of data based on statistics of general human face characteristics. Fortunately, the recognition system operated by FACE++ has a large facial-characteristic database to enable the results to be more reliable. Accordingly, preferred embodiments employ an external facial recognition service to reduce the computational requirements of the terminals to allow more cost effective production of same.

Once the AVIA software has received the returned message from the facial recognition server, it will make any necessary calculations and upload the result with a terminal ID number to the database of the IDK server. In one embodiment, this message for each image will at least document the number of faces (total audience views), gender and age information of each face, with glasses or without glasses. By comparing the changes of recognition results from one image to the next for a given terminal, the system can estimate the number of actual views, and how long each detected viewer actually spent viewing the displayed content on the display screen of the terminal.

Because every display terminal has a unique ID number in the database, and each facial recognition result set is related in the database to the terminal ID number and timestamp, statistical calculation and recording can be performed for any number of desired purposes. For example, of a user wants to know the total views on Saturday of January 2015 for a display terminal at the entrance of one building, the user can get the ID number of that terminal by query from the database with a location record of the terminals. Using the timestamp records for that given terminal ID, the server can tally the total number of views of that terminal on that given day.

The result data communicated to the database server by the terminal also may contain a content ID value pre-assigned to each piece of display content displayable on the screen, whereby the output from a terminal that is set up to display different content can be filtered or queried to review the viewership data for a particular content item. Alternatively, rather than attaching a content ID to the results being sent to the database server by the terminal, other methods of associating the facial recognition results from a given image to the content displayed at that image's time of capture may be employed, for example by maintaining a content display record that tracks what content is displayed at any given time. For example, in the case of a video advertisement, this data of the content display record, or media play record, can be used to determine the time slot at which the commercial video clip was played during the a time period of interest, and then the timestamps of the facial recognition results are used to calculate all the faces recorded in the database for this time slot. Among the facial recognition data, the gender ratio, race and age group of reviewers can be reviewed, for example for use by the advertiser to determine whether they are reaching a target demographic, or to identity demographics to whom their ads are appealing.

Since all the accumulated information is stored in the database of the backend server, the system may employ a web-based content management system, for example using HTML 5.0, to show the analyzed data as required, and issue results in a log report. For example, the view times per day or in a special period, the gender spec for some commercial advertisements, etc.

While the forgoing embodiments have been described in terms of an informational display terminal, e.g. a freestanding computer terminal or kiosk that stands upright to place a relatively large display screen at an elevated height above the ground at or near eye-level of the average population, the AVIA software may similarly be executed on other camera equipped computerized devices operable to display advertising or other media content on their display screens, for example, for monitoring viewership of media content on mobile devices, e.g. smart phones, tablet computers, laptop computers; or stationary computers, e.g. desktops, workstations, video game consoles, etc.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A computerized display device with viewer data collection capabilities, the device comprising:
a processor;
at least one computer readable memory medium coupled to the processor and comprising computer readable memory having stored thereon statements and instructions for execution by the processor;
a display connected to the processor and operable to display visual content thereon;
a camera connected to the processor and operable to capture digital images of a surrounding environment in which the display device resides; and
a network connection interface coupled to the processor and operable to connect to a communications network and communicate with a remote facial recognition server via said communications network;
wherein the statements and instructions are configured to:
trigger capture of a digital image by the camera and store said digital image on the computer readable memory medium; and
initiate a facial recognition process for performing detection and analysis of facial characteristics of a viewer whose face was recorded within the digital image by forwarding the digital image data through the communications network to the remote facial recognition server for detection and analysis thereby of said facial characteristics of the viewer whose face was captured within the digital image; and
retrieve or accept results of the analysis from the facial recognition server, including a number of faces detected for said image and gender and age information of each face, and, at a remote server, store said results of the analysis in association with local data from the display device, said local data comprising a timestamp associated with the capture of the digital image and a device ID of the display device.

2. The device of claim 1 wherein the statements and instructions are configured to perform a modification of the digital image and generate the digital image data from said modification.

3. The device of claim 2 wherein the statements and instructions are configured to adjust a brightness of the digital image during said modification.

4. The device of claim 2 wherein the statements and instructions are configured to reduce a size of the digital image during said modification.

5. The device of claim 2 wherein the statements and instructions are configured to reduce a size of the digital image during said modification.

6. (canceled)

7. The device of claim 1 wherein said device is an informational display terminal installed in a public space.

8. The device of claim 7 wherein said informational display terminal is a freestanding kiosk.

9. The device of claim 1 wherein the local data comprises a content ID associated with the visual content item shown on the display when the digital image was captured.

10. The device of claim 1 in combination with said remote server, wherein said remote server maintains a database that stores said results of the analysis in association with said local data from the display device, and also stores a location record for said device.

11. The device of claim 10 wherein said database stores additional locations for a plurality of like devices, and the server is configured to enable user-querying of the location records to find a particular device at a particular location of interest and view the results of the analysis from the facial recognition server for images captured by said particular device.

12. The device of claim 11 wherein the server is configured to receive a user-specified period of time that the server compares against the timestamps of the images captured by said particular device to report to the user on the results of the analysis from the facial recognition server for images captured by said particular device during said user-specified period of time.

13. (canceled)

14. (canceled)

15. (canceled)

16. (canceled)

17. (canceled)

18. (canceled)

19. (canceled)

20. (canceled)

21. A method of monitoring viewership of content displayed on a plurality of display devices, the method comprising:
electronically storing results from a facial recognition process performed on digital images captured by cameras of the display devices, including storing a respective result set for each digital image and storing each respective result set in association with data by which identification can be made of a respective visual content item that was displayed on a respective display device that captured said digital image at a moment when said digital image was captured, each respective result set including a number of detected faces in said digital image and gender and age information for each detected face in said digital image; and
electronically generating at least one report concerning viewership of the respective visual content item for at least one of said digital images based on the respective result set and the associated data;
wherein generating the at least one report comprises generating a device-specific report using only the results for which the data concerning the display device comprises a specific device ID assigned to a particular one of the display devices.

22. The method of claim 21 wherein generating the at least one report comprises generating a content-specific report using only the results for which the data concerning the display devices comprises a specific content ID for a particular piece of visual content shown on the display devices.

23. The method of claim 21 wherein generating the at least one report comprises generating a time-specific report using only the results for which the data concerning the display device comprises image timestamps falling within a user-specified period of time.

24. The method of claim 21 wherein generating the device-specific report first comprises receiving a user-query performed on location records of the display devices to identify said specific device ID based on a particular location of said particular one of the display devices.

25. The method of claim 21 wherein at least one of said display devices is an informational display terminal installed in a public space.

26. The method of claim 25 wherein said informational display terminal is a freestanding kiosk.

27. A computerized system for displaying advertising or other informational content and monitoring viewership of same, the system comprising:
a plurality of display devices each comprising a display operable to display visual content thereon, and a camera connected to the processor and operable to capture digital images of a surrounding environment in which the display device resides, each display device being configured to trigger capture of a digital image by the camera and store said digital image on the computer readable memory medium, and initiate a facial recognition process for performing detection and analysis of facial characteristics of a viewer whose face was recorded within the digital image; and
a server connected to a communication network and configured to receive results from the facial recognition process, including at least a number of faces for each digital image and gender and age information of each face, via said communication network, and store said results in association with data concerning which one of said display devices captured the digital image, said data comprising a timestamp indicative of a time at which the digital image was captured by the display device and a device ID of a specific one of said display devices that captured the digital image.

28. (canceled)

29. (canceled)

30. (canceled)

31. (canceled)

32. The system of claim 27 wherein at least one of said display devices is an informational display terminal installed in a public space.

33. The system of claim 32 wherein said informational display terminal is a freestanding kiosk.

34. (canceled)

35. (canceled)

36. (canceled)
